(19) United States
(12) Patent Application Publication
(10) Pub. No.: US 2018/0196843 A1
(43) Pub. Date: Jul. 12, 2018

(54) ERROR DETECTION AND CORRECTION FOR ENTERPRISE RESOURCE PLANNING SYSTEMS

(71) Applicant: LCR-Dixon Corporation, Bel Air, MD (US)

(72) Inventors: Jeffrey J. BLEACHER, Bel Air, MD (US); Susan M. SOO, Carmel Valley, CA (US)

(21) Appl. No.: 15/863,659

(22) Filed: Jan. 5, 2018

Related U.S. Application Data
(63) Continuation-in-part of application No. 13/747,055, filed on Jan. 22, 2013.
(60) Provisional application No. 61/588,832, filed on Jan. 20, 2012.

(51) Int. Cl. G06F 17/30; G06Q 40/00; G06Q 30/04; G06Q 10/06

(52) U.S. Cl. CPC G06F 17/30371; G06Q 10/0631; G06Q 30/04; G06Q 40/123

(57) ABSTRACT

Accounting functionality integratable into an ERP system such as, e.g., SAP® is described. The functionality provides multiple features including automatically detecting and correcting information in records relied upon by the ERP system so that subsequent ERP processes may properly act on the corrected information.

### CROSS-REFERENCE TO RELATED APPLICATIONS

This is a Continuation-in-Part application of co-pending U.S. patent application Ser. No. 13/747,055 filed Jan. 22, 2013, which claims benefit and priority to U.S. Provisional Application No. 61/588,832 filed Jan. 20, 2012, the disclosures of which are incorporated by reference herein in their entirety.

### BACKGROUND

### 1.0 Field of the Disclosure

This disclosure is directed generally to a system and method for providing enhanced error detection and correction of data and messages flowing into or out of corporate enterprise resource planning (ERP) systems and, more particularly, to a system, computer program product, and method for providing enhanced automatic error detection and correction of data and messages flowing into or out of ERP or similar system to automatically detect and correct messages or information relied upon by the ERP system to avoid or reduce incorrect or inaccurate enterprise operations thereby providing a more efficient system.

### 2.0 Related Art

An ERP system typically integrates areas such as, e.g., planning, purchasing, inventory, sales, marketing, finance and human resources. ERP systems routinely process information received from users, from outside systems, from local or remote databases, from users, or the like, and is relied upon for controlling and managing enterprise operations. Typically, much of the information flow relied upon by an ERP system is often critical information related to the operations of the enterprise and if the information is incorrect when acted upon, the results may lead to adverse consequences to the enterprise.

ERP systems tend to process data as provided, with little or no detection of invalid or incorrect data. Even small or seemingly inconsequential errors in information used by the ERP system may have singular or cumulative adverse consequences. For example, if a value of a parameter relied upon by the ERP system for processing information or managing operations frequently tends to be inaccurate, e.g., off by a small percentage, the results over time can lead to substantial unnecessary loss of productivity or revenues, unnecessary expenditures of time, money or other assets, unnecessary risk, or the like.

An automated/real time solution to automatically detect and correct information relied upon by the ERP system may improve enterprise operational effectiveness overall including, e.g., avoiding loss of inventory, avoiding loss of revenue or avoiding unneeded expenditures.

### SUMMARY OF THE DISCLOSURE

Additional features, advantages, and embodiments of the invention may be set forth or apparent from consideration of the following attached detailed description. Moreover, it is to be understood that both the foregoing summary of the invention and the following attached detailed description are exemplary and intended to provide further explanation without limiting the scope of the invention as claimed.

/*** TO BE FINALIZED BY McGUIREWOODS ONCE CLAIMS ARE AGREED **/

### BRIEF DESCRIPTION OF THE DRAWINGS

FIG. 1A is a block diagram of an Enterprise Resource Planning (ERP) system 100 that may include one or more additional components, configured according to principles of the disclosure;

FIG. 1B is an example functional illustration showing a high-level flow of events related ERP systems prior to this disclosure;

FIG. 1C is an example functional illustration showing a high-level flow of events related ERP systems, in accord with principles of the disclosure;

FIG. 2 is a flow diagram of the process controlled and/or provided by the VR 200 module, the process performed according principles of the invention;

FIG. 3 is a flow diagram showing steps of FB60/Manual non-purchase order invoice processing, performed according to principles of the invention;

FIG. 4 is a flow diagram of a VR process for automated invoices, performed according to principles of the invention;

FIG. 5 is a flow diagram showing how VR 200 adjusts invoices, performed according to principles of the invention,

FIG. 6A is an illustration of a screenshot that a user may view during the processing of VR 200, configured according to principles of the invention;

FIG. 6B is an illustration of a screenshot that a user may view showing a result of the processing of VR 200 for the invoice of FIG. 6A, configured according to principles of the invention;

FIG. 7A is an illustration of a screenshot that a user may view during the processing of VR 200, configured according to principles of the invention.

FIG. 7B shows a screenshot showing the VR 20 result, configured according to principles of the invention;

FIGS. 8A to 8E show screenshots of a scenario where a vendor overcharges a tax amount, configured according to principles of the invention;

FIG. 9A shows an example of VR 200 configuration table, configured according to principles of the invention;

FIG. 9B shows a table that defines for what countries VENDORecon should be used, configured according to principles of the invention;

FIG. 10 is a flow diagram showing flexRFC 300, performed according to principles of the invention;

FIG. 11 shows a screenshot of a Create Tax Accruals, configured according to principles of the invention;

FIG. 12 shows an exemplary table showing a list of source financial documents requiring a tax accrual, according to principles of the invention;

FIG. 13 shows an exemplary screenshot of part of a screenshot showing a tax calculated in test mode, according to principles of the invention;

FIG. 14 shows a screenshot showing a FI document posted with a tax accrual expense, according to principles of the invention;

FIG. 15 shows a screenshot of a tax accrual report;

FIG. 16 is a flow diagram showing the decision points and outcome options for flexRFC processing, performed according to principles of the invention;

FIG. 17 shows an example of a FI accounting document automatically created by a flexRFC to expense tax accrual, configured according to principles of the invention; and

FIG. 18 shows an exemplary screenshot of the use tax accrual in a third party Tax Software reporting that may be exported for tax returns purposes, configured according to principles of the invention;

FIG. 19 is an example illustration of an extract user interface 1900 to select which line level details from A/P documents in the ERP to gather for storing critical data fields for each transaction, according to principles of the disclosure;

FIG. 20 is an illustration of a taxability matrix that illustrates taxability of purchases, according to principles of the disclosure;

FIG. 21 is an example illustration of an output in spreadsheet format showing actual tax outcomes for every A/P invoice line selected for processing and compares the result to an expected tax outcome or rules override, according to principles of the disclosure;

FIG. 22 is an example of a user interface for displaying or assigning rules to SAP data elements as captured by the extract user interface user selections (“drivers”), in accordance with principles of the disclosure; and

FIG. 23 is an example process for detecting and correcting ERP/SAP records, according to principles of the disclosure.

### DETAILED DESCRIPTION OF THE INVENTION

The disclosure and the various features and advantageous details thereof are explained more fully with reference to the non-limiting embodiments and examples that are described and/or illustrated in the accompanying drawings and detailed in the following description. It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments of the disclosure. The examples used herein are intended merely to facilitate an understanding of ways in which the disclosure may be practiced and to further enable those of skill in the art to practice the embodiments of the disclosure. Accordingly, the examples and embodiments herein should not be construed as limiting the scope of the disclosure. Moreover, it is noted that like reference numerals represent similar parts throughout the several views of the drawings.

A “computer”, as used in this disclosure, means any machine, device, circuit, component, or module, or any system of machines, devices, circuits, components, modules, or the like, which are capable of manipulating data according to one or more instructions, such as, for example, without limitation, a processor, a microprocessor, a central processing unit, a general purpose computer, a super computer, a personal computer, a laptop computer, a palmtop computer, a notebook computer, a desktop computer, a workstation computer, a server, or the like, or an array of processors, microprocessors, central processing units, general purpose computers, super computers, personal computers, laptop computers, palmtop computers, notebook computers, desktop computers, workstation computers, servers, or the like. Further, the computer may include an electronic device configured to communicate over a communication link. The electronic device may include, for example, but is not limited to, a mobile telephone, a personal data assistant (PDA), a mobile computer, a stationary computer, a smart phone, mobile station, user equipment, or the like.

A “server”, as used in this disclosure, means any combination of software and/or hardware, including at least one application and/or at least one computer to perform services for connected clients as part of a client-server architecture. The at least one server application may include, but is not limited to, for example, an application program that can accept connections to service requests from clients by sending back responses to the clients. The server may be configured to run the at least one application, often under heavy workloads, unattended, for extended periods of time with minimal human direction. The server may include a plurality of computers configured, with the at least one application being divided among the computers depending upon the workload. For example, under light loading, the at least one application can run on a single computer. However, under heavy loading, multiple computers may be required to run the at least one application. The server, or any if its computers, may also be used as a workstation.

A “database”, as used in this disclosure, means any combination of software and/or hardware, including at least one application and/or at least one computer. The database may include a structured collection of records or data organized according to a database model, such as, for example, but not limited to at least one of a relational model, a hierarchical model, a network model or the like. The database may include a database management system application (DBMS) as is known in the art. The database may be distributed over one or more networks. The at least one application may include, but is not limited to, for example, an application program that can accept connections to service requests from clients by sending back responses to the clients. The database may be configured to run the at least one application, often under heavy workloads, unattended, for extended periods of time with minimal human direction.

A “network,” as used in this disclosure, means an arrangement of two or more communication links. A network may include, for example, the Internet, a local area network (LAN), a wide area network (WAN), a metropolitan area network (MAN), a personal area network (PAN), a campus area network, a corporate area network, a global area network (GAN), a broadband area network (BAN), any combination of the foregoing, or the like. The network may be configured to communicate data via a wireless and/or a wired communication medium. The network may include any one or more of the following topologies, including, for example, a point-to-point topology, a bus topology, a linear bus topology, a distributed bus topology, a star topology, an extended star topology, a distributed star topology, a ring topology, a mesh topology, a tree topology, or the like.

A “communication link”, as used in this disclosure, means a wired and/or wireless medium that conveys data or information between at least two points. The wired or wireless medium may include, for example, a metallic conductor link, a radio frequency (RF) communication link, an Infrared (IR) communication link, an optical communication link, or the like, without limitation. The RF communication link may include, for example, WiFi, WiMAX, IEEE 802.11, DECT, 0G, 1G, 2G, 3G or 4G cellular standards, Bluetooth, or the like.

The terms “including”, “comprising” and variations thereof, as used in this disclosure, mean “including, but not limited to”, unless expressly specified otherwise.

The terms “a”, “an”, and “the”, as used in this disclosure, mean “one or more”, unless expressly specified otherwise.

Devices that are in communication with each other need not be in continuous communication with each other, unless expressly specified otherwise. In addition, devices that are in communication with each other may communicate directly or indirectly through one or more intermediaries.

Although process steps, method steps, algorithms, or the like, may be described in a sequential order, such processes, methods and algorithms may be configured to work in alternate orders. In other words, any sequence or order of steps that may be described does not necessarily indicate a requirement that the steps be performed in that order. The steps of the processes, methods or algorithms described herein may be performed in any order practical. Further, some steps may be performed simultaneously.

When a single device or article is described herein, it will be readily apparent that more than one device or article may be used in place of a single device or article. Similarly, where more than one device or article is described herein, it will be readily apparent that a single device or article may be used in place of the more than one device or article. The functionality or the features of a device may be alternatively embodied by one or more other devices which are not explicitly described as having such functionality or features.

A “computer-readable medium”, as used in this disclosure, means any medium that participates in providing data (for example, instructions) which may be read by a computer. Such a medium may take many forms, including non-volatile media, and volatile media. Non-volatile media may include, for example, optical or magnetic disks and other persistent memory. Volatile media may include dynamic random access memory (DRAM). Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read.

Various forms of computer readable media may be involved in carrying sequences of instructions to a computer. For example, sequences of instruction (i) may be delivered from a RAM to a processor, (ii) may be carried over a wireless transmission medium, and/or (iii) may be formatted according to numerous formats, standards or protocols, including, for example, WiFi, WiMAX, IEEE 802.11, DECT, 0G, 1G, 2G, 3G or 4G cellular standards, Bluetooth, or the like.

The various aspects of the invention as set forth in the attachment includes a new approach to automated tax diagnostics including an automated/real time solution to improve the accuracy of tax calculations related to ERP systems and third party tax software programs. The disclosure may refer to specific third party software programs such as, e.g., Tax Engine, however it should be understood that other third party software programs may be used and not limited to the specific third party tax software.

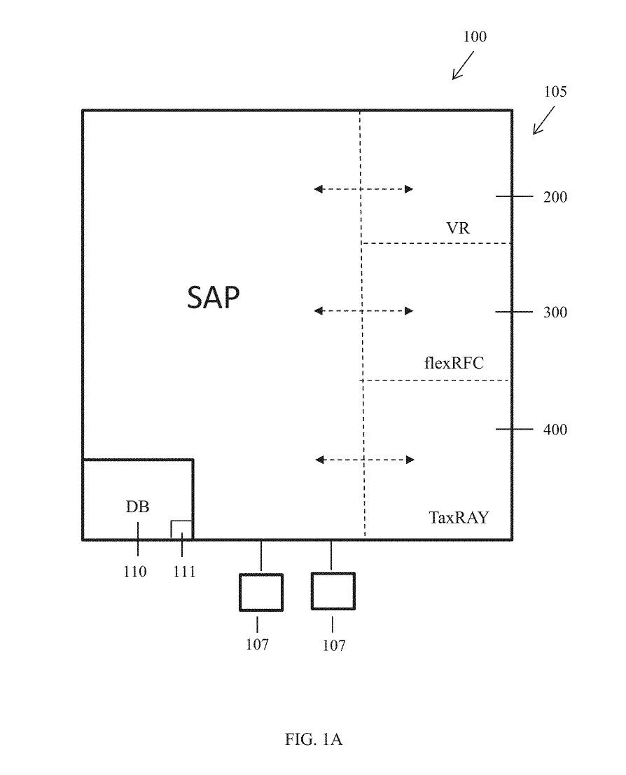

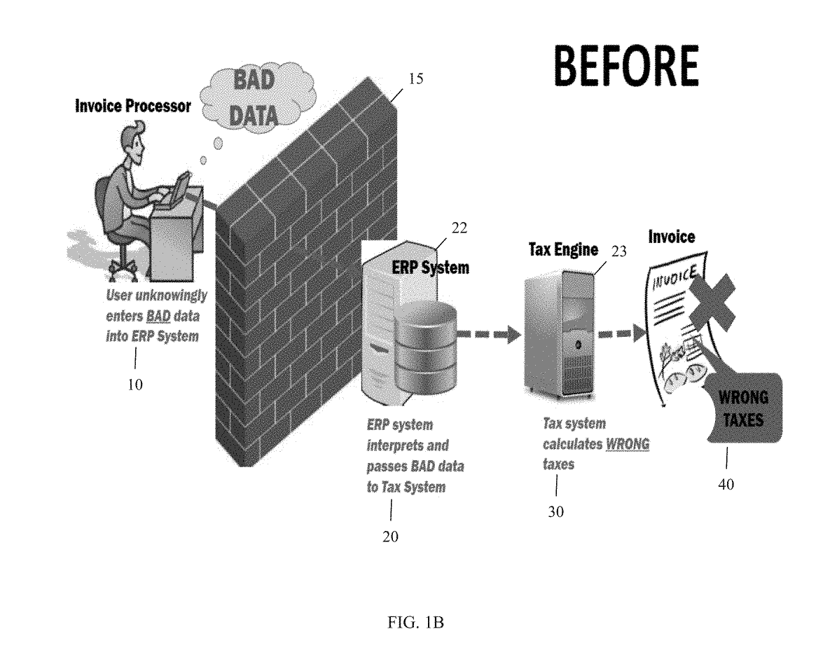

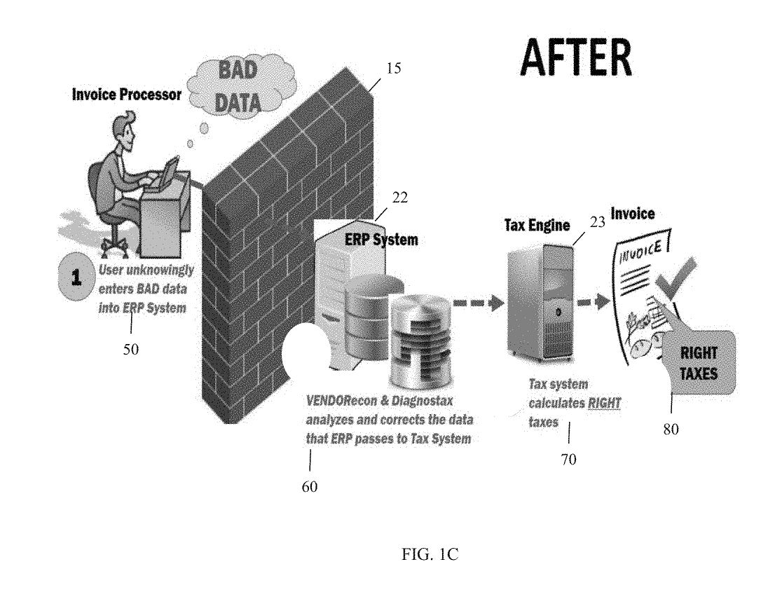

FIG. 1A is a block diagram of an Enterprise Resource Planning (ERP) system 100 that may include one or more additional components, configured according to principles of the disclosure. The ERP system 100 may comprise, e.g., a SAP® platform that permits integration of one or more third-party supplied modules 200, 300, 400 for expanding functional capability of the ERP system 100. The ERP system 100 comprises one or more computer platforms 105 that run the various traditional applications of an ERP system 100. The one or more computer platforms 105 may also incorporate the execution of the modules 200, 300 and 400, described more below. The system may also include one or more user interface devices 107, such as terminals or computers, for interaction (input and/or output) with the ERP applications and modules 200, 300 and 400. Modules 200, 300 and 400 may be software programs. The system 100 may include a database 110 for storing enterprise records including, e.g., accounting records, material management records, financial records, tax records, inventory records, and the like. The database 110 may serve as an input and output device. The components of the ERP system 100 may be distributed. The database 110 may also store administrable rules 111 for use in detecting and correcting incorrect information in ERP/SAP records.

FIG. 1B is an example functional illustration showing a high-level flow of events related ERP systems prior to this disclosure. At step 10 a user may enter bad data into the ERP system that may be stored in a database at the ERP system 22. Alternatively, the bad data may be introduced by errors occurring in associated electronics and storing procedures, such as electronic damage. The ERP system 22 may be protected behind a firewall 15. At step 20 the ERP system 22 may interpret and pass bad data to the tax system 23. At step 30, the tax engine 23 may access and employ the bad data to calculate incorrect output related to the ERP system. In this example, the incorrect output may comprise an incorrectly stated invoice which may include incorrect data such as, e.g., incorrect tax. FIG. 1C is an example functional illustration showing a high-level flow of events related ERP systems, in accord with principles of the disclosure. At step 50, a user may unknowingly enter bad data in to the ERP system 22, at step 60 the ERP system 22 may automatically detect and automatically correct the bad data, based on techniques describe more below, passing the corrected information to the tax engine 23 which produces a correct invoice.

In one aspect of the invention, a system and method (referred to generally as VENDORecon) for reconciling tax amounts calculated by different sources, such as, e.g., a vendor and an accounting system. In particular, VENDORecon (or “VR”) may comprise module 200 that may include a suite of custom Advanced Business Application Programming (ABAP) code that may be invoked during SAP® MM (Purchase Order related) and FI invoice (non-Purchase Order related) pre-processing and creation to automate the reconciliation between vendor-billed tax and tax calculated by any third party tax software operable with ERP systems, such as, but not limited to, for example, Tax Engine, OneSource™, Taxware™, Sales Tax Office™, and the like (hereinafter Tax Software). The VENDORecon module 200, may offer the following functionality:
Integration with the SAP® invoice processing screens and programs where VR is virtually invisible to accounts payable (A/P) users, but the results during invoice “simulation” or posting making A/P processing much more efficient;
Table configuration to define documents that should invoke or bypass VR;
Desired outcomes can be configured based on variables such as tax codes, invoice thresholds, vendors, states, overpayment vs. underpayment and taxability;
Outcomes can be controlled based on tolerances that are percentage-based or dollar-based;
Capable of handling manually input invoices or automated invoices, such as IDocs/electronic data interchange (EDI). (IDoc is a standard data structure for electronic data interchange (EDI) between application programs written for the SAP® software business system or between an SAP® software application and an external program.)
Ability to handle invoice-level or line-level reconciliations (depending on the manner in which vendor tax is input); and/or
Error messaging may be configurable according to requirements.

THE VENDORecon module 200 may be delivered in a series of SAP® transport files containing the VR data dictionary object and program(s). As part of a typical installation process, the VR 200 may be integrated with the ERP system 100, such as SAP® system user exits and/or Badis.

The VENDORecon module 200 may be configurable to determine an outcome (e.g., an output) based on variables such as tax codes, invoice thresholds, vendors, states, overpayment vs. underpayment and taxability.

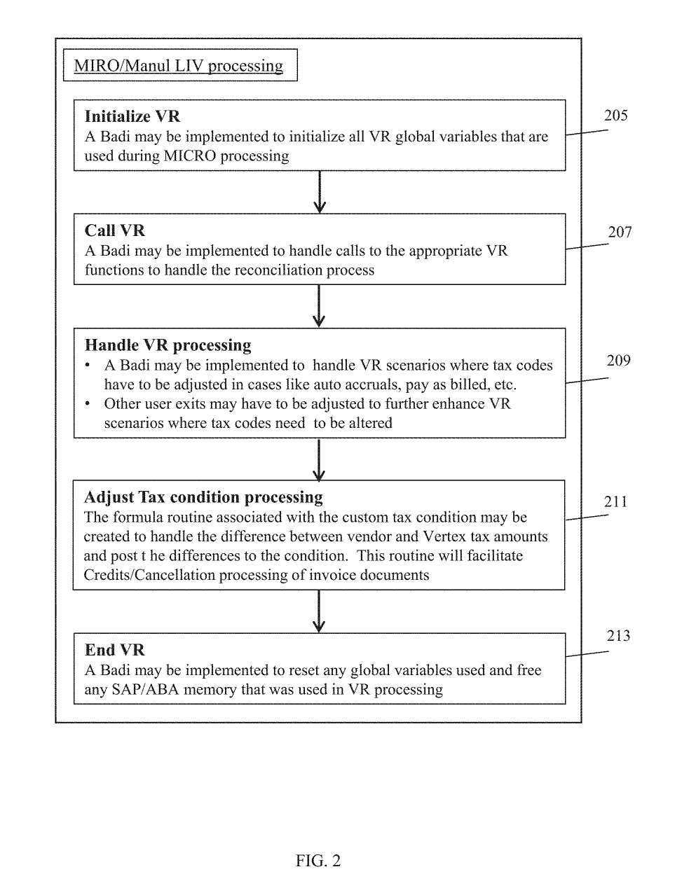

FIG. 2 is a flow diagram of the process controlled and/or provided by the VR 200 module, the process performed according principles of the invention. VR 200 includes function modules and may include classes/methods that are implemented within an ERP 100 environment (such as, e.g., SAP®) and may be called during, e.g., Materials Management (MM) or FI Invoice pre-processing, creation or change processes, and the like. FIG. 2 (and all other flow diagrams herein) may equally represent a high-level block diagram of components of the invention implementing the steps thereof. The steps of FIG. 2 (and all other flow diagrams herein)) may be implemented on computer program code in combination with the appropriate computing hardware. This computer program code may be stored on storage media such as a diskette, hard disk, CD-ROM, DVD-ROM or tape, as well as a memory storage device or collection of memory storage devices such as read-only memory (ROM) or random access memory (RAM). Additionally, the computer program code can be transferred to a workstation over the Internet or some other type of network. The program code may be embodied on a computer medium as a computer product, the code when read and executed performs the functions of the program code (such as the flow diagrams herein).

The process of FIG. 2 is for purchase order based invoicing. At step 205, a Badi (Business Add-In) may be implemented to initialize all VR variables that may be used during VR micro processing. At step 207, VR may be called to handle calls to appropriate VR functions to handle reconciliation process. At step 209, a Badi is implemented to handle VR scenarios where tax codes have to be adjusted in cases like accruals, pay as billed, and the like. Additional user exits are provided to handle tax codes that need to be altered. At step 211, adjusting of a tax condition may occur. The formula associated with the custom tax condition may be created to handle the difference between vendor and third party tax amounts (e.g., Tax Engine tax amounts). At step 213, a Badi is implemented to reset any global variables used to free any memory that was used during the VR processing.

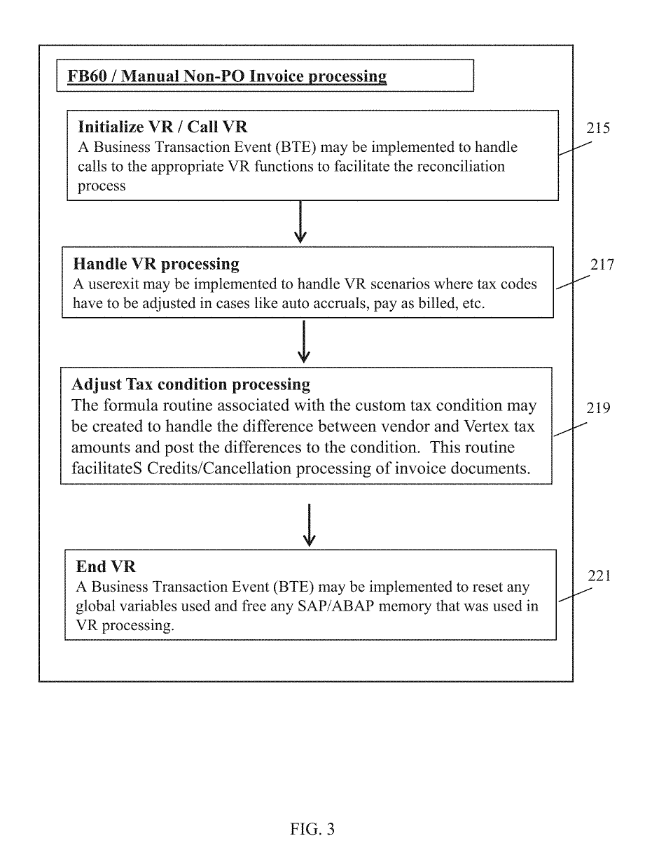

FIG. 3 is a flow diagram showing steps of FB60/Manual non-purchase order invoice processing, performed according to principles of the invention. At step 215, a business transaction event (BTE) is implemented to handle calls to appropriate VR functions to facilitate reconciliation. At step 217, a user exit is implemented to handle VR scenarios where tax codes have to be adjusted in cases like accruals pay as billed, and the like. At step 219, a tax condition may be adjusted. The formula associated with the custom tax condition is created and the difference handled between the vendor and third party tax (e.g., Tax Engine) amounts and the difference is posted to the condition. This facilitates credits/cancellation processing of invoice documents. At step 221, a business transaction event (BTE) is implemented to reset any global variables used and free any memory (e.g., SAP®/ABAP memory) that was used in the VR processing.

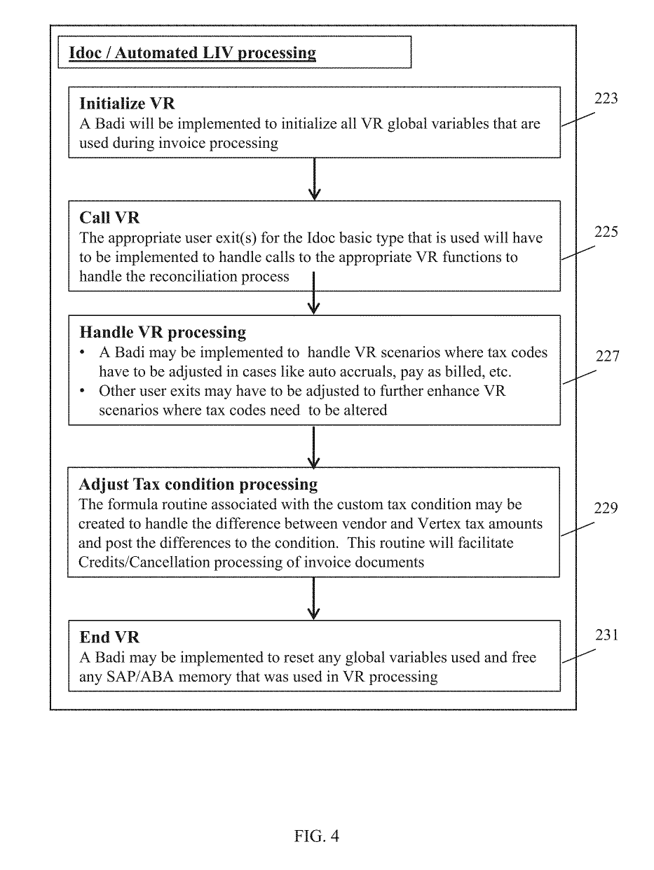

FIG. 4 is a flow diagram of a VR process for automated invoices, performed according to principles of the invention. At step 223, a Badi is implemented to initialize all VR global variables that are used during invoice processing. At step 225, the appropriate user exit for Idoc types is called to handle the VR reconciliation process. At step 227, a Badi is implemented to handle VR scenarios where tax codes have to be adjusted like auto accruals, pay as billed and the like. Other user exits may be implemented where tax codes need to be altered. At step 229, a tax condition may be adjusted. The formula associated with the custom tax condition is created and the difference handled between the vendor and third party tax (e.g., Tax Engine) amounts and the difference is posted to the condition. This facilitates credits/cancellation processing of invoice documents. At step 231, a Badi is implemented to reset any global variables used and to free any memory (e.g., SAP®/ABAP memory).

The VR 200 module automatically performs several functions during SAP A/P invoicing, including the following steps:
Bifurcates processing for manual versus automated processing. Manual invoices may be created by direct user input via invoice screens such as MIRO (PO related) and FB60. Automated invoices are auto-generated from external systems or files (such as Idoc/EDI invoices).
Validates that the invoice should invoke the VR process. This may be based on the T-code, document type, country and/or tax procedure.
Determines if the VR process should handle at a line or invoice level. This distinction is that the line level VR processing reconciles each line item individually, whereas invoice (or header) level VR processing reconciles the invoice as a whole. A deciding factor is whether the vendor-billed taxes are entered into SAP® (or other ERP) on a line level or header level basis.
Compares tax software calculation tax to vendor-billed tax. This affects the type of adjustment needed.
Determines the outcome based on settings within the tax tolerance table by either:
   Automatically reconciling and balancing the taxes by one of the flowing:
      Paying the vendor as billed
      Accruing all tax if not billed by the vendor
      Accruing partial tax not billed by the vendor
      Short-paying the vendor
      Displaying an error or warning message for the user, or
      Leaving the invoice out of balance for manual adjustment
Depending on the outcome, handling the accounting entries—to adjust the third party tax (e.g., Tax Engine or vendor tax) and post to the proper general ledger (GL) accounts and tax conditions.
Depending on the outcome, showing a message—for the user, or a printed/stored message in the Text field of the invoice for printing on a check remittance stub.

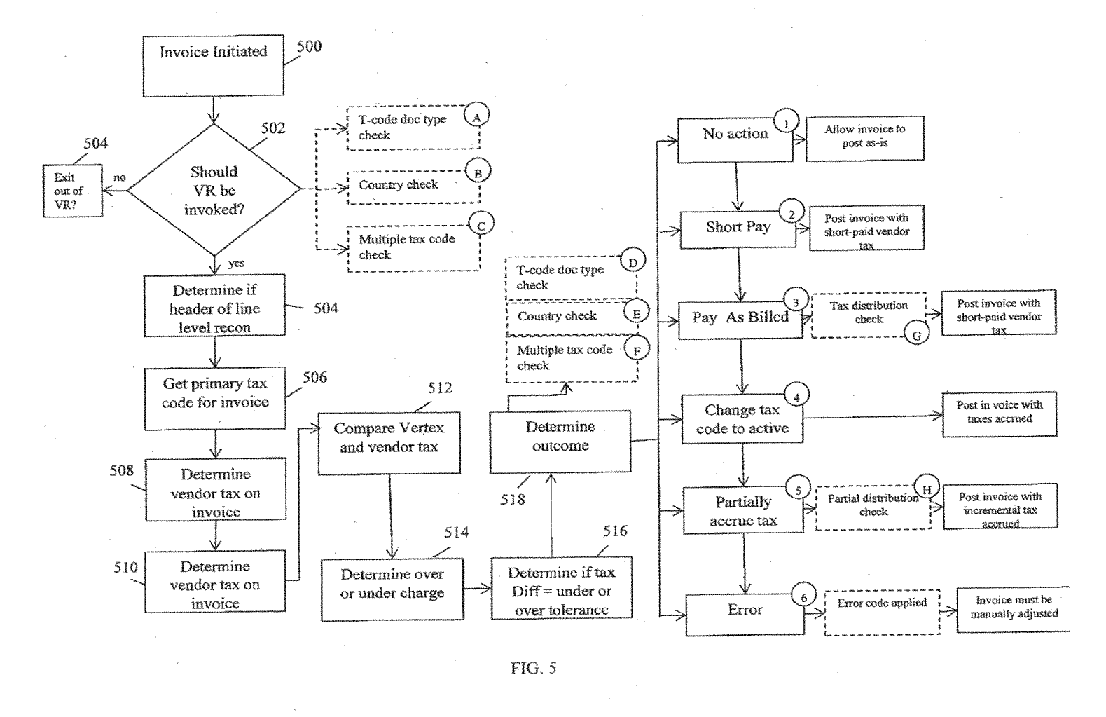

FIG. 5 is a flow diagram showing how VR 200 adjusts invoices, performed according to principles of the invention. At step 500, an invoice is initiated. At step 502 a check is made to determine if VR should be invoked. This may include checking the T-code document type, country code and/or multiple tax code. If it is determined that VR 200 should not be invoked, then the process may end at step 504. If however, VR 200 should be invoked, then at step 504, a determination is made if a header or line level reconciliation is appropriate. At 506, the primary tax code for the invoice is obtained. At step 508, determine the vendor tax on the invoice. At step 512, the third party tax (e.g., Tax Engine tax) is compared to the vendor tax. At step 514, an over or under charge is determined. At step 516, a determination of a tax difference is made. This may be accomplished by reading the configuration tables of VR 200. As a result, several outcomes may be possible as denoted by reference numerals 1-6. These include: no action, short pay (part of bill is paid), pay as billed, change tax code to active, partially accrue tax, or an error may be generated.

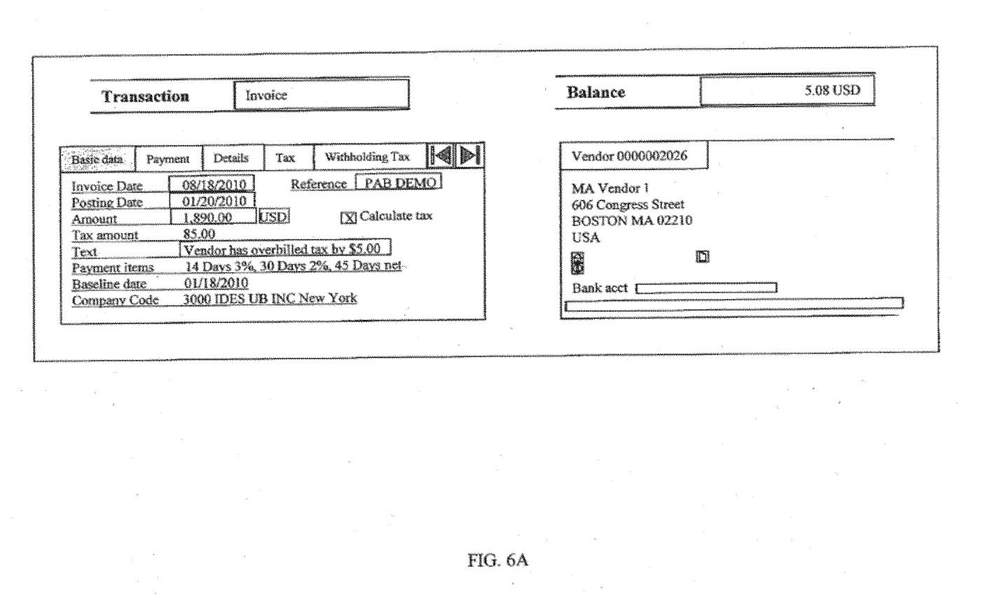

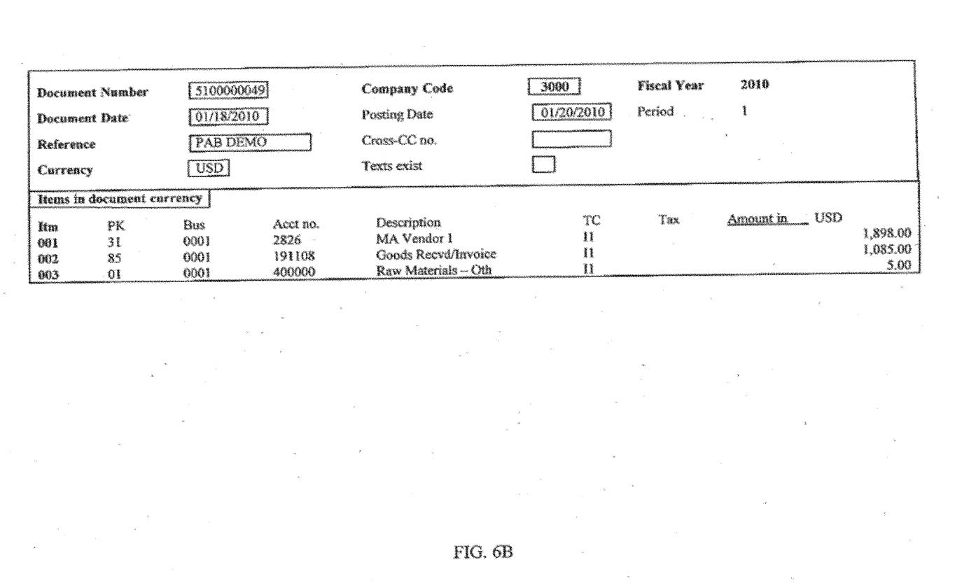

FIG. 6A is an illustration of a screenshot that a user may view during the processing of VR 200, configured according to principles of the invention. In this scenario, a vendor has billed Company 3000 a $90.00 tax shown in the invoice. According to tax software the tax should be $85 dollars. This is an overcharge of $5.00, but Company 3000 wishes to pay the vendor as billed ($90.00). In FIG. 6A, VR 200 has automatically adjusted the amount expensed to include the additional $5.00 tax charge by the vendor. Since this may be within an acceptable range, the vendor may be paid as billed.

FIG. 6B is an illustration of a screenshot that a user may view showing a result of the processing of VR 200 for the invoice of FIG. 6A, configured according to principles of the invention. VR 200 has automatically adjusted the amount expensed to include an additional $5.00 tax charged (as raw materials) by the vendor.

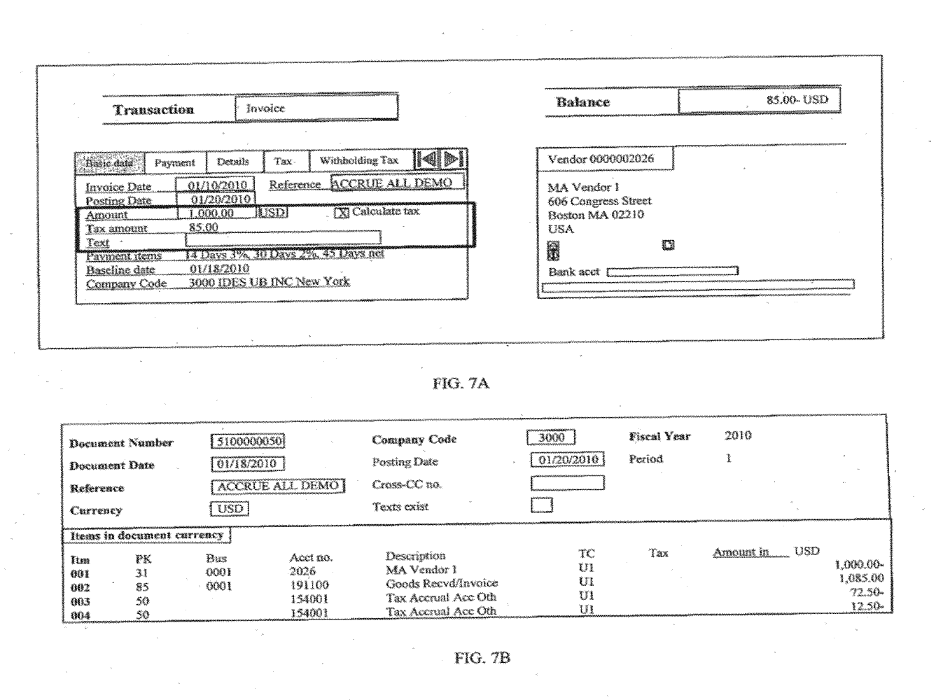

FIG. 7A is an illustration of a screenshot that a user may view during the processing of VR 200, configured according to principles of the invention. In this scenario, a vendor did not bill any tax. The vendor has under billed by $85.00 when compared to a third party tax (e.g., Tax Engine). VR 200 automatically flips the tax code to U1, i.e., to accrue. FIG. 7B is a screenshot showing the VR 20 result, configured according to principles of the invention. The full $85.00 is accrued.

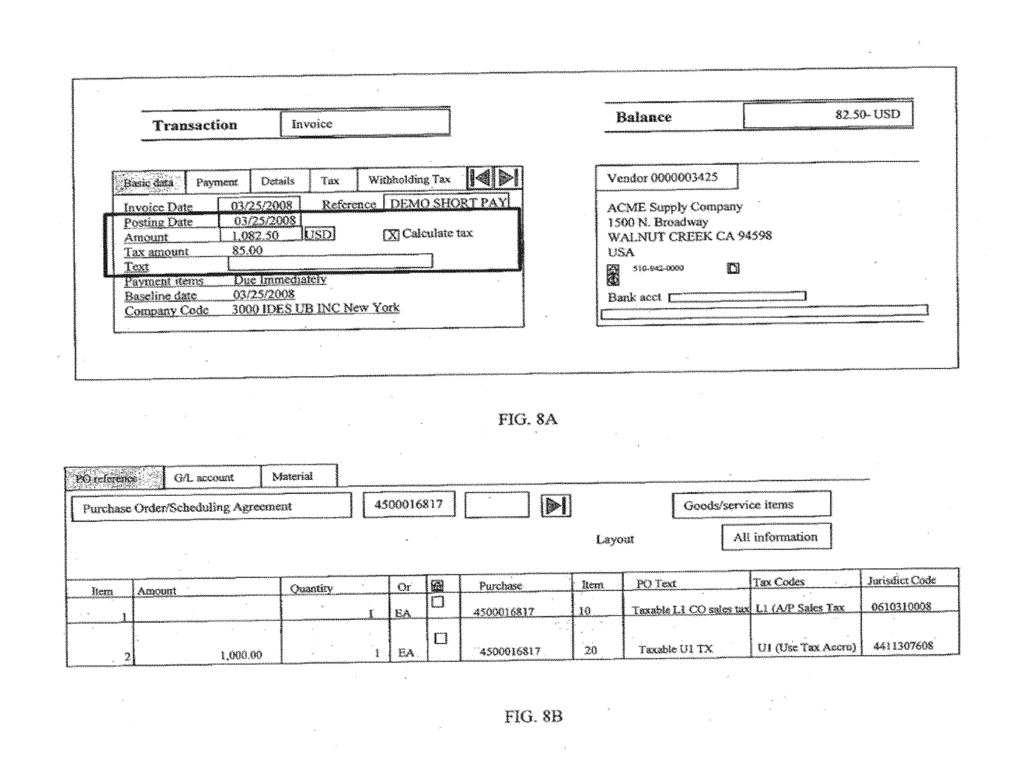

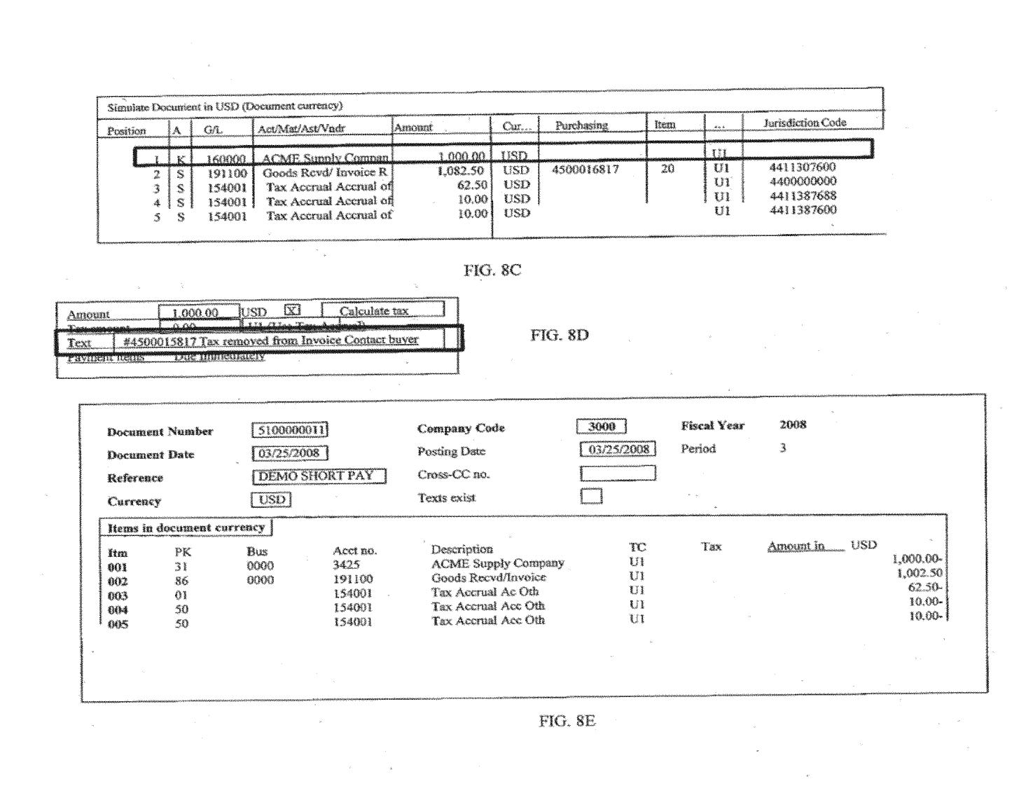

FIGS. 8A to 8E show screenshots of a scenario where a vendor overcharges a tax amount, configured according to principles of the invention. FIG. 8A shows that the vendor (ACME Supply Company) has over-billed Company 3000 by $82.50 on a direct pay invoice. FIGS. 8B and 8C show that VR 200 automatically adjusts the vendor payable amount to exclude the tax, leaving $1000.00. FIG. 8D shows that a message (highlighted) may be automatically generated to appear on a check remittance stub. FIG. 8E shows that the invoice has been short paid by the tax amount and that the tax is accrued.

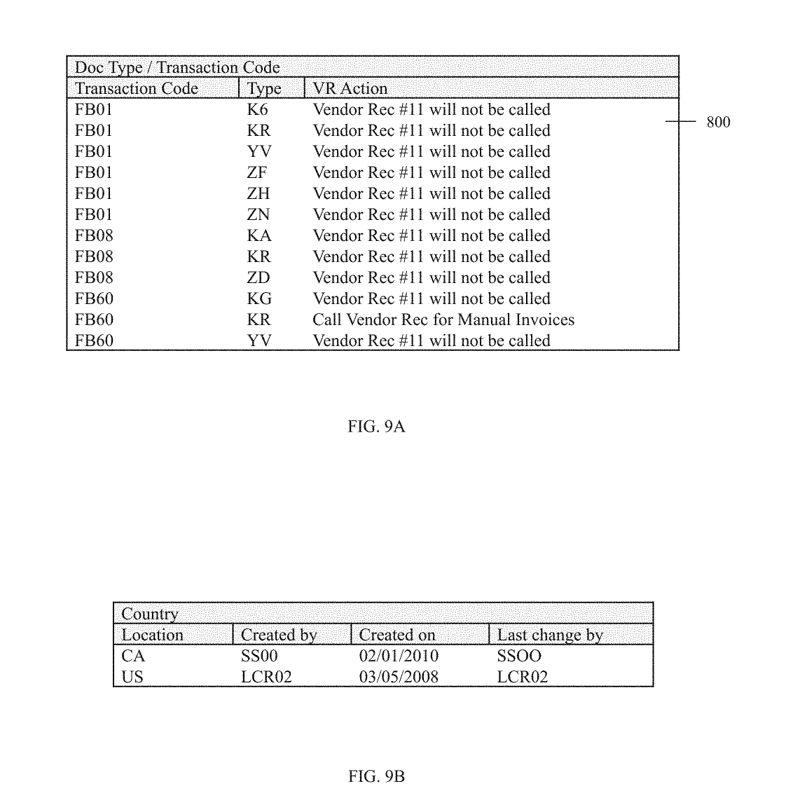

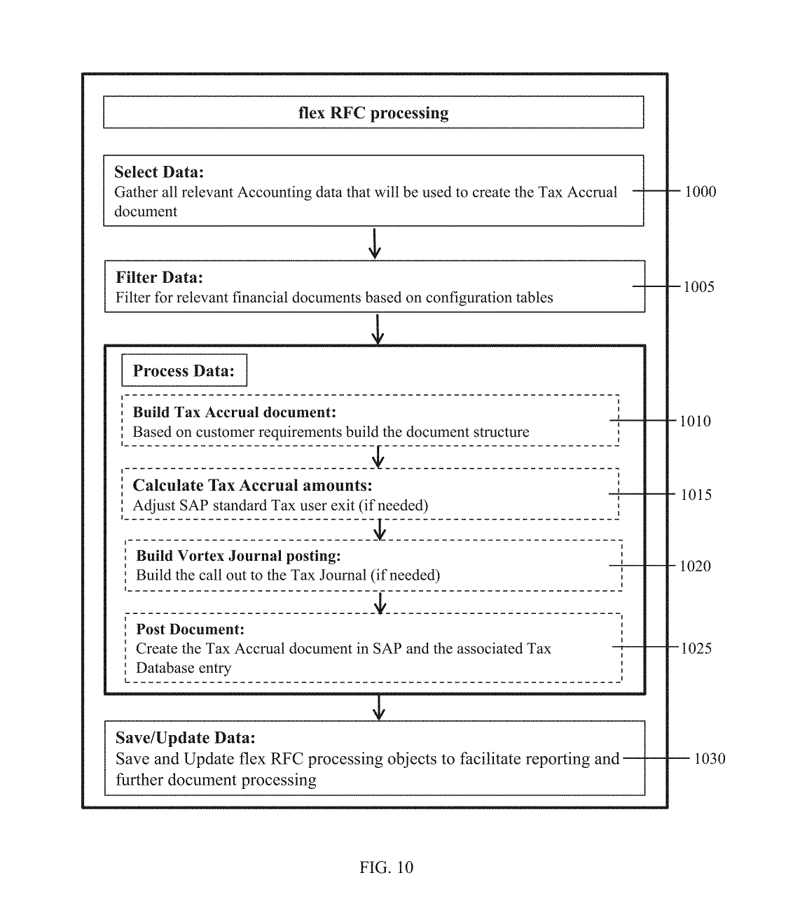

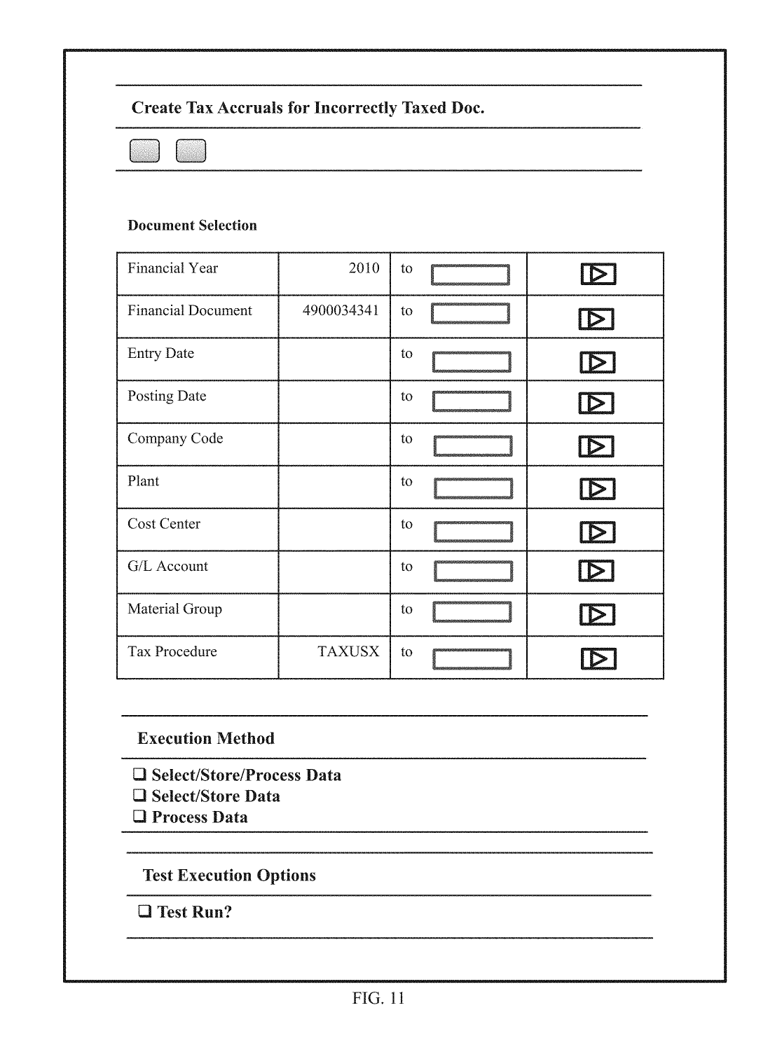

FIG. 9A shows an example of VR 200 configuration table, configured according to principles of the invention. The table 800 is organized by SAP® transaction code (column labeled Transaction Code) and document type (column labeled Type) with a column defining whether or not VENDORecon (VR 200) will be called. Possible VR actions may include: call VENDORecon for automated invoices (such as EDI, Idocs, etc), call VENDORecon for manual invoices (like MIRO or FB60 transaction codes) or VENDORecon is not to be called. FIG. 9B is a table that defines for what countries VENDORecon should be used, configured according to principles of the invention. In the example of FIG. 9B, VENDORecon is to be called only for invoices with a US or Canadian company code.

The following requirements should be considered and defined prior to configuring the VR tables:
Does VR need to be invoked for US invoices only, or are other country's invoices going to be involved?
   See “Country” Table in the previous section of this document
   Invocation of VR can be based on Tax Procedure or country of the SAP® company code
What transactions and document types should invoke or bypass VR?
   See “Doc Type/Transaction Code” table in the previous section of this document. Decisions should be made on the following types of invoices:
      Manual invoices (i.e., MIRO and FB60)
      Automated invoices (i.e., EDI, IDocs)
Should VR reconcile the invoice at the header/invoice level or on the line level?
   The key driver behind this is whether vendor-billed tax is entered at a line level or the header level.
Define the tax difference tolerances
   VR allows tolerances to be defined on the Tax Difference Amount or Percentage to prevent VR from automatically reconciling large dollar tax differences.
   Tax Difference Amounts—Dollar difference between the tax software tax and the tax charged by the Vendor
      Vendor tax $6.00
      Tax software tax $8.00
      Tax Difference Amount $−2.00
   Tax Difference Percentage—Tax difference may be defined as the relative percentage of the Tax Engine tax
      Vendor tax $10.00
      Tax software tax $8.00
      Tax Difference % 25%
   Tax Difference Percentage—Tax difference may be defined as the absolute percentage of the Tax Engine tax
      Tax Base $100.00
      Vendor tax $10.00
      Tax software tax $8.00
      Tax Difference % 2%
Define the outcomes of the VR module 200, based on the possible scenarios and variables such as invoice amount, tax code, vendor, state, tax software taxability, tax difference tolerances and under/overcharge. The VR 200 logic may result in the following outcomes:
   No adjustment needed—the invoice is in balance and can be posted as-is.
   Pay the vendor as billed (PB) and allocate/post the adjustment to the expense account. A prerequisite for this outcome is the creation of an additional custom Tax Condition (in the Tax Procedure) to handle the tax adjustment. A control total can be defined so that taxes paid as billed do not exceed a reasonable amount (e.g., 10% or 20%).
      For multiple line invoices that are processed at Invoice level VR, any tax adjustment posted to the Custom Tax Condition (as a result of the Pay-as-Billed or PB outcome) needs to be allocated among the lines for expense purposes. The pro-ration rules are defined in the “PB Distribution” table.
   Accrue the entire tax amount with a specific tax code because the vendor did not bill any tax.
   Accrue part of the tax amount that the vendor did not charge. The distribution of this partial accrual can be pro-rated among the state, county, city and district levels and this can be defined in the “Partial Accrual Distribution.”
   Error because VR cannot reconcile the outcome.
Define the Return Messages on Manual Invoices

In another aspect of the invention, a system and method for calculating and recording tax accruals on inventory movements, tax only debits and credits for both AP and AR, allocation of tax, and the like, is provided and generally includes module 300, referred to as flexRFC. In particular, the flexRFC 300 enables SAP® systems and tax software users to create tax adjustments in SAP® records while maintaining the integrity of the tax calculation and reporting data from/in the tax software. In one aspect, flexRFC 300 may enable the tax software to use tax accruals on inventory movements processed in the SAP® Material Movements program. FlexRFC 300 functionality may include one or more of the following:
Generates the Remote Function Call (RFC) to a tax software to calculate the use tax;
Creates the necessary FI documents to post any tax accruals to the GL;
Posts the use tax accrual to the Tax Software Tax Journal or Register File to facilitate returns preparation;
Allows users to restrict the type of transactions that will run through the flexRFC accrual process—by variables such as movement type, cost center, general ledger (GL) account and plant;
Allows users to view and select the line items that are to be processed by flexRFC prior to creating financial documents;
Can be executed on a scheduled or on-demand basis and in test mode prior to FI posting;
Facilitates large volumes of accruals with background program option; and/or
Compatible with Tax Software such as, e.g., Tax Engine Q-Series and O-Series, OneSource, Taxware, and Sales Tax Office.

FIG. 10 is a flow diagram showing the processing of flexRFC 300, performed according to principles of the invention. At step 1000, all relevant material movement data that will be used to create a tax accrual document may be gathered. At step 1005, relevant movement documents may be filtered base on configuration tables. At step 1010, a tax accrual document may be built based on a customer's requirements. At step 1015, tax accrual amounts may be calculated. SAP® standard tax user exit may be adjusted as necessary. At step 1020, a Tax Engine Journal posting may be built, if needed. At step 1025, a tax accrual document may be built in SAP® and the associated Tax Engine, or other third party tax software, tax entry. At step 1030, goods movement objects may be updated and saved to facilitate reporting and further document processing.

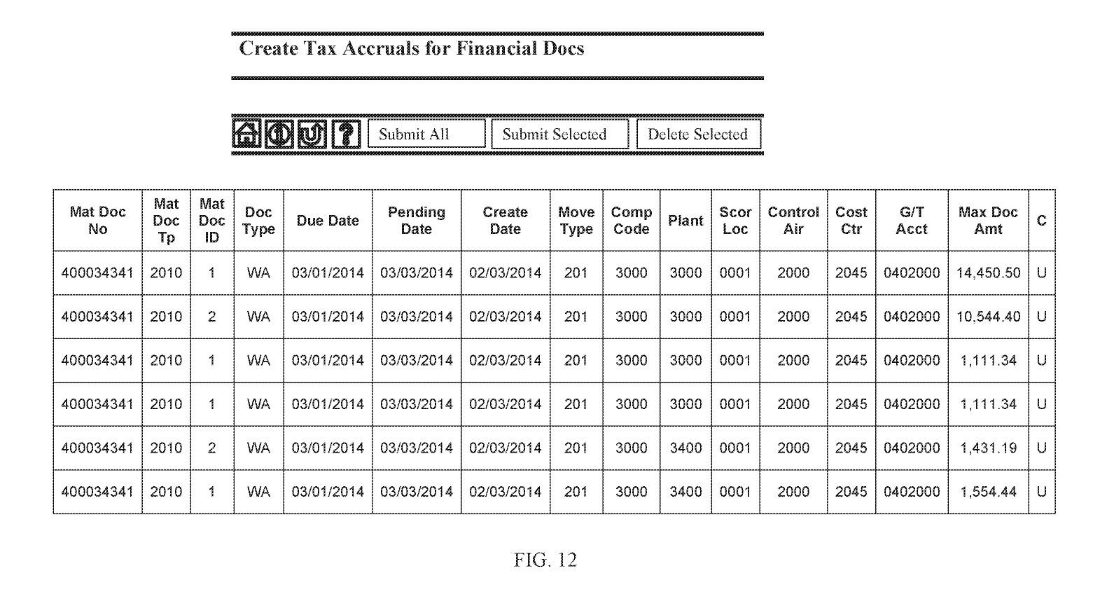

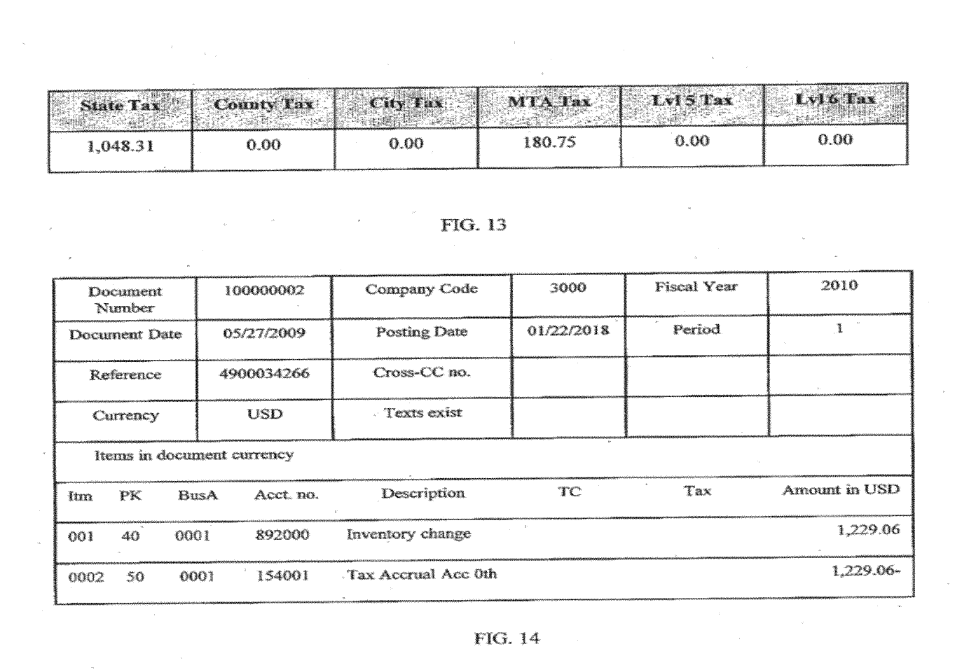

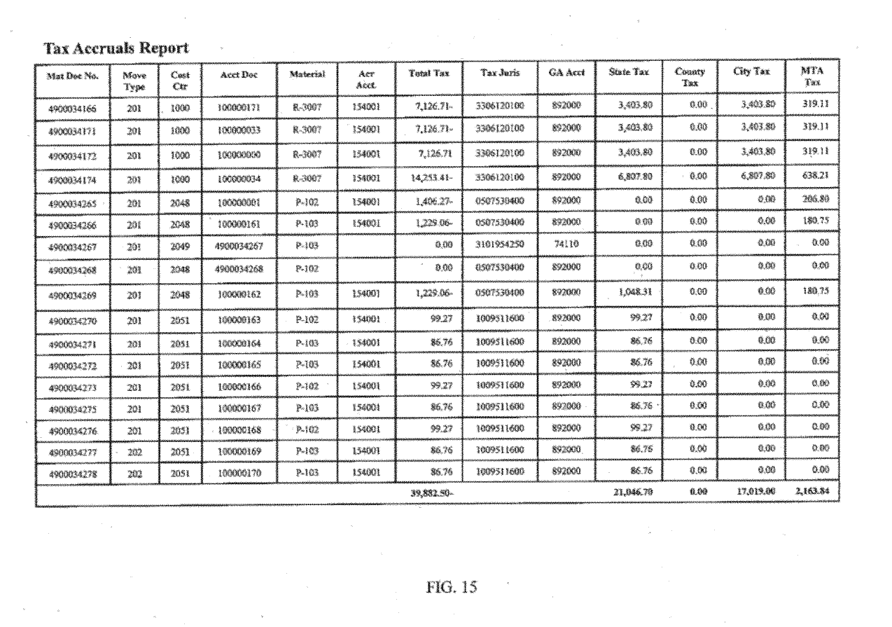

FIG. 11 is a screenshot of a Create Tax Accruals, configured according to principles of the invention. Once parameters (such as Company code and posting dates) for desired accruals have been defined, the program may be executed in FM (function module) which posts tax accruals only, or BDC (Batch Data Communications) modes. Upon execution, the Goods Movement program of flexRFC 300 may perform the following:
Gathers financial documents subject to tax accrual based on the input parameters and configuration tables:
   Movement type
   Company code
   Plant/storage location
   Cost objects—assets, cost centers, internal orders, WBS elements
   General Ledger (GL) accounts
FIG. 12 presents a list of financial documents for the user to:
   Submit all,
   Submit selected, or
   Delete selected, for Tax accrual function
The flexRFC program may process each submitted material movement document by initiating a remote function call to Tax Engine (or other similar program) and sending the data to Tax Engine to determine the use tax. The standard data passed from SAP® to Tax Engine may include, but is not limited to:
   SAP® Company code=Tax Engine Taxpayer ID
   Material Movement posting date=Tax Engine Invoice (tax) date
   Tax accrual posting date=Tax Engine posting (reporting) date
   SAP® material document amount=Tax Engine gross amount
   Cost center tax jurisdiction code=Tax Engine ship-to location
Tax Engine determines the use tax and returns the amount to the flexRFC program
After the tax is returned to the flexRFC program,
   If flexRFC is run in Test mode: no FI document is created, but the tax calculated can be seen directly on the screen as shown in FIG. 13.
   If flexRFC is run in full mode, the FI document is posted with the tax accrual expense and references to the original Financial Document as shown in the screen shot of FIG. 14.
The flexRFC program stores the Accruals on the tax accrual report as shown in FIG. 15.

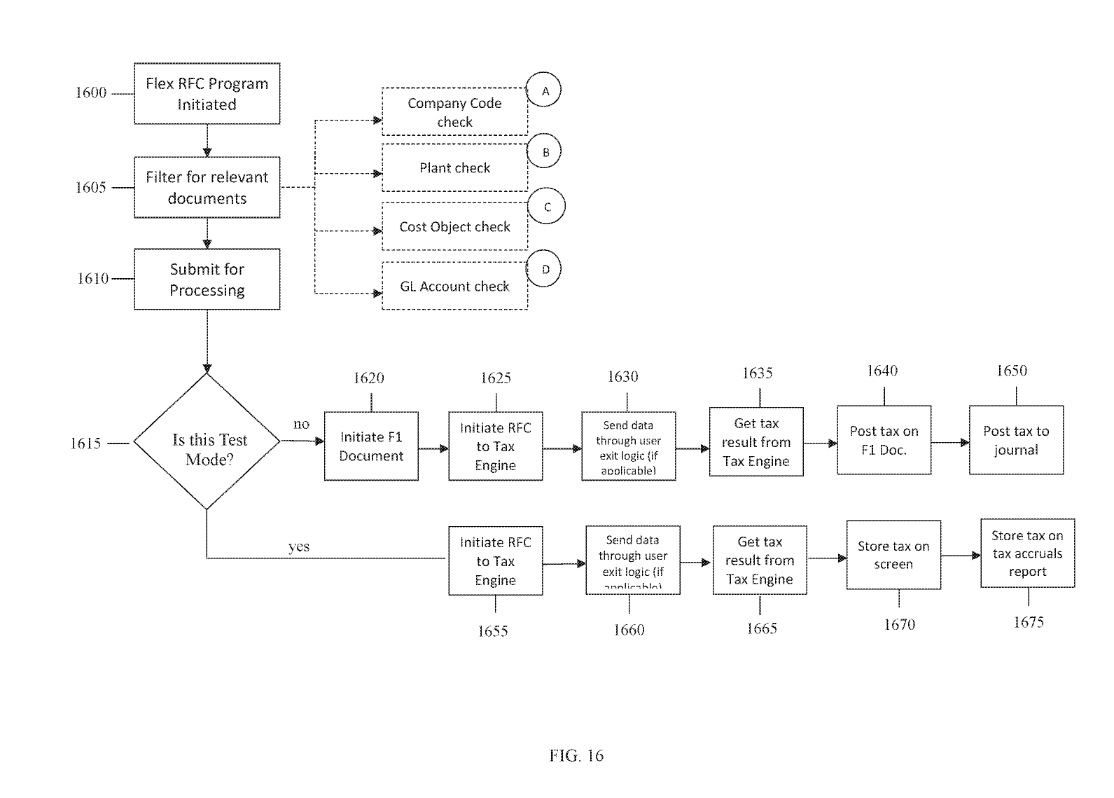

FIG. 16 is a flow diagram showing the decision points and outcome options for flexRFC processing, performed according to principles of the invention. At step 1600 flexRFC processing may be initiated. At step 1605, documents are filtered for relevance. At step 1610, documents are submitted for processing. At step 1615, a check is made as to whether or not this is a test mode. If not, then at step 1620 FI document is initiated. At step 1625, a remoter function call (RFC) may be made to Tax Engine. At step 1630, data may be sent through user exit logic (if applicable). At step 1635, a tax result may be obtained from Tax Engine. At step 1640, the tax may be posted on a FI document. At step 1650 the tax may be posted to the Tax Engine journal.

If at step 1615 the result is a test mode, then at step 1655, a RFC is made to Tax Engine. At step 1660, relevant data may be sent through user exit logic, if applicable. At step 1665, a tax result is obtained from Tax Engine. At step 1670, the tax may be stored on screen. At step 1675 the tax may be stored on the tax accrual report.

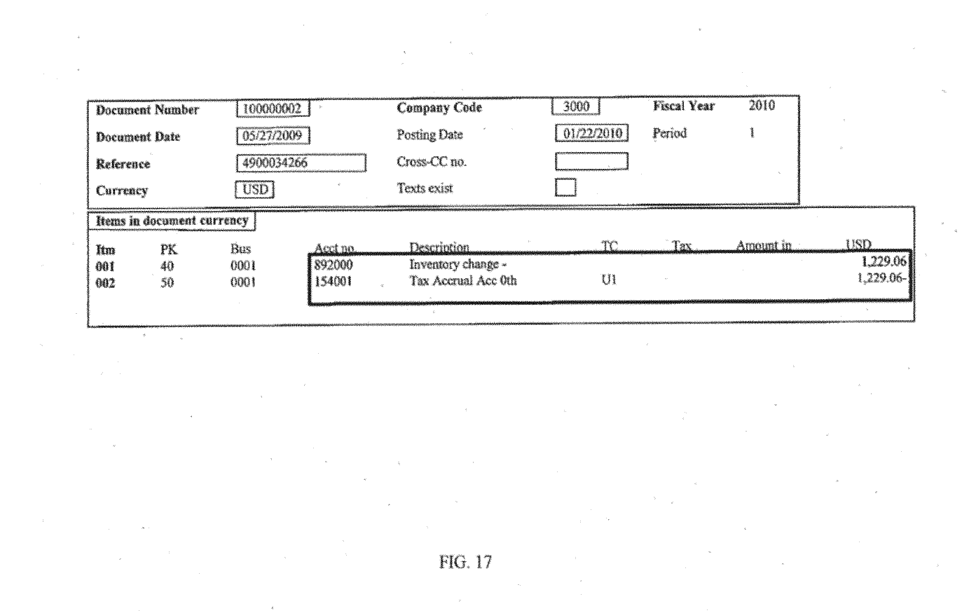

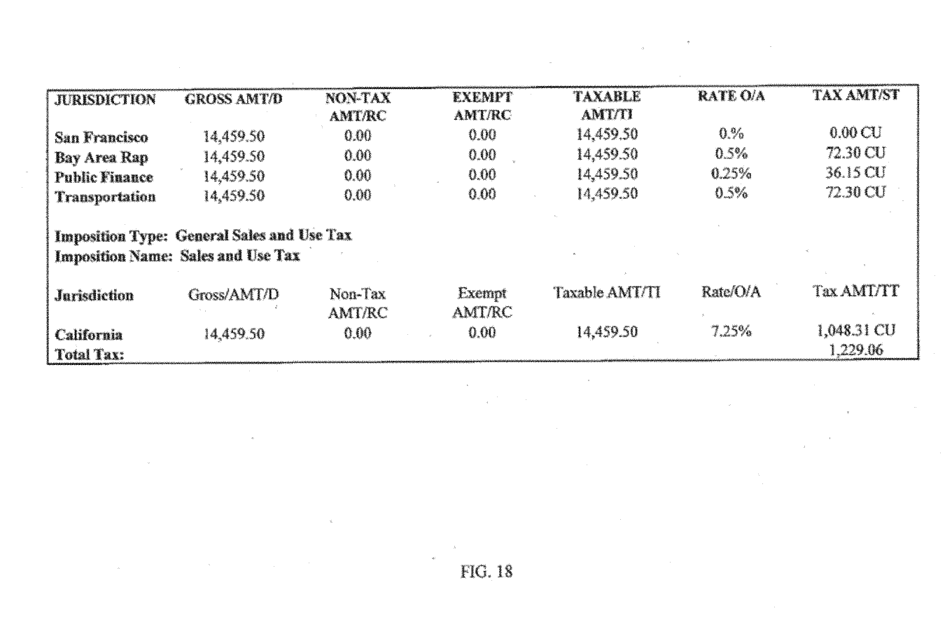

As a result of the exemplary process of FIG. 16, FIG. 17 shows an FI accounting document automatically created by the flexRFC to expense tax accrual and FIG. 18 shows an exemplary screenshot of the use tax accrual in Tax Engine reporting that may be exported to Tax Engine returns. flexRFC posts the tax accrual to the Tax Engine journal/register file. The posting reflects tax due for California being $1,048.31.

In a further aspect of the invention, a system and method for evaluating the accuracy of transaction tax results is provided and includes module 400 generally referred to as Diagnostax. In particular, the Diagnostax comprises a suite of custom ABAP code that automates the process of evaluating the accuracy of transaction tax results on procure-to-pay (P2P) transaction data. Diagnostax may offer one or more of the following functionalities:
Screens that look and feel like standard SAP® programs—Diagnostax runs within the SAP® application environment and can be executed on a scheduled or on-demand basis;
Table configuration to define documents that should be analyzed by Diagnostax;
Analysis can be configured based on variables such as one or more of (or all): tax codes, vendors, GL accounts, material groups, cost objects and expected taxability by state;
Analysis and evaluations can be defined by matching key-word variables and multi-point verifications; and/or
Capable of handling evaluations on PO and Invoice data.

Diagnostax may be installed and integrated with ERP system 100. Diagnostax analyzes gaps in reporting data such as internal audit reports and identifies gaps (e.g., incorrect amounts) in the calculated tax amounts. A user may run the Diagnostax functions at will and may receive outputs of indications of gaps in tax amounts for transactions. A user may search for a specific issue related to an identified issue and manually intervene to resolve the discrepancy.

For example, transactions involving Office Supplies are usually taxable transactions in most states. Running Diagnostax may identify a gap in the taxable amount for a transaction. Alternatively, a user of Diagnostax may search for Diagnostax reports involving Office Supplies. A user may then identify a solution to a discrepancy and construct a rule for Office Supplies that may be automatically applied to future transactions involving Office Supplies as being taxable, and may apply a particular rate, for example. Thereafter, every transaction involving Office Supplies may be checked to verify accuracy in system transactions. The corrections/revisions may be stored in the ERP 100 database 115.

Diagnostax may be configured to conduct validation checks during a diagnostic run including one or more of:
Validates that the invoice should invoke the Diagnostax process based on a number of variables such as Transaction Code, Document Type, Country and Tax Procedure.
Validates Tax Codes. Compares the Tax Code on the transaction line to the Rules Uploaded to confirm the correct Tax Code is on the transaction. This feature will allow you to confirm Direct Pay, non-Direct Pay and exempt Tax Code defaults. The program also identifies the tax relevant transactions missing tax codes.
Conducts WordLink validations of Exempt Tax Codes. For Exempted Tax Codes (that did not call the external tax system), the Diagnostax program may run through a series of checks to validate that the transaction is most likely exempt. It is possible to validate the Exempt Tax Code based on WordLink checks in the Vendor, GL account, Cost Objects and Line Item Descriptions.
Conducts WordLink validations of data selections. For GL accounts and/or Material Groups entered, Diagnostax may compare with Good and Bad WordLink associations to flag Good and Bad data selections. These can be used for training and internal audit purposes.
Conducts WordLink validations of Tax Outcomes. For transaction lines, Diagnostax may compare the ultimate tax outcome (Taxable or Exempt) with wordlink combinations to determine if possible incorrect results appear. For example, if Diagnostax sees tax paid on “Legal Fees”, it will flag it as possible overpaid.
Conducts System Compare of Tax Outcomes. For transaction lines, Diagnostax may compare the ultimate tax outcome (Taxable or Exempt) with rules uploaded to validate if the outcome is consistent with the rules.
Rate Check. For transaction lines, Diagnostax may compare the actual tax rate paid or accrued with the standard rate in the Tax System and flag differences.
   This feature can identify transactions where vendors were paid as billed or a non-standard rate was applied.
Calculate Tax Check—This validation provides dollar and line item statistics by AP user on checking or un-checking the Calculate Tax and Calculate Taxes on Net settings.
TJC Check—WordLink validations maybe used to validate that specific Tax Jurisdiction Codes (TJCs) are acceptable when tied to certain plants, cost objects, vendors, line item descriptions. For example, if a transaction has a TX TJC, but the plant is in CA, this might raise a review flag.
Statistics—all outcomes, tax calculations, flagged items, data selections, user processing can be compiled for statistical reporting. This feature can provide significant benefit for internal audit, training and management purposes.
Linkage to Scanned Images—for transactions flagged for review, the user can execute a utility that may retrieve the scanned images linked to the invoice (if available) and store it for easy access when reviewing the flagged lines. In addition, the user can record data from the invoice in Diagnostax (such as ship-to, actual item purchased) so Diagnostax can run through a second round of analysis to determine the correct outcome based on the data extracted from the scanned image.

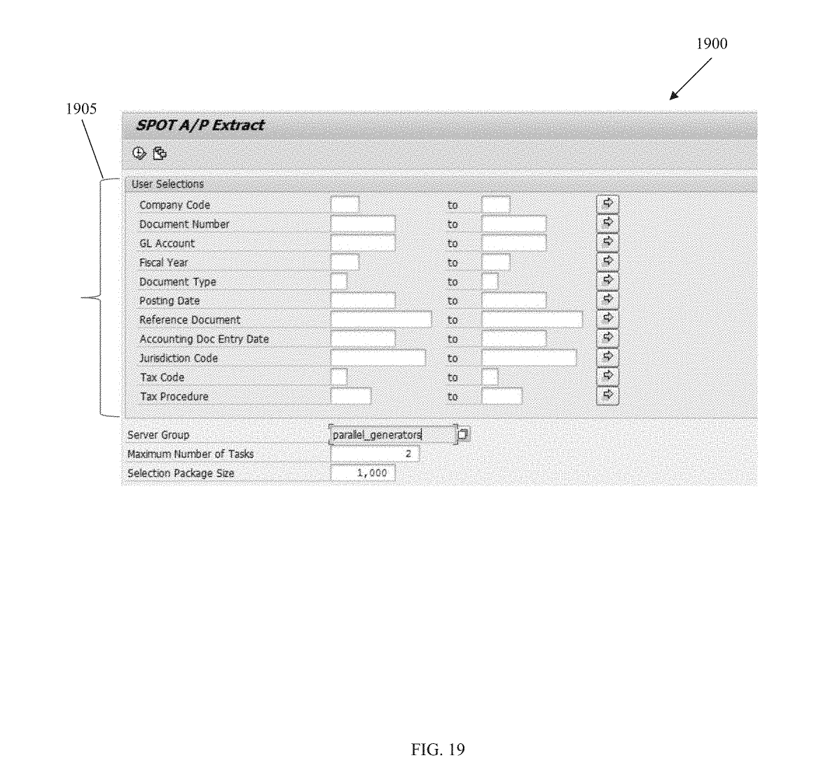

FIG. 19 is an example illustration of an extract user interface 1900 to select which line level details from A/P documents in the ERP to gather for storing critical data fields for each transaction, according to principles of the disclosure. The user sections 1905 may include, e.g., company code, document number, GL account, fiscal year, docuetmsn type, posting data, reference document, accounting document entry date, jurisdiction code, tax code, tax procedure.

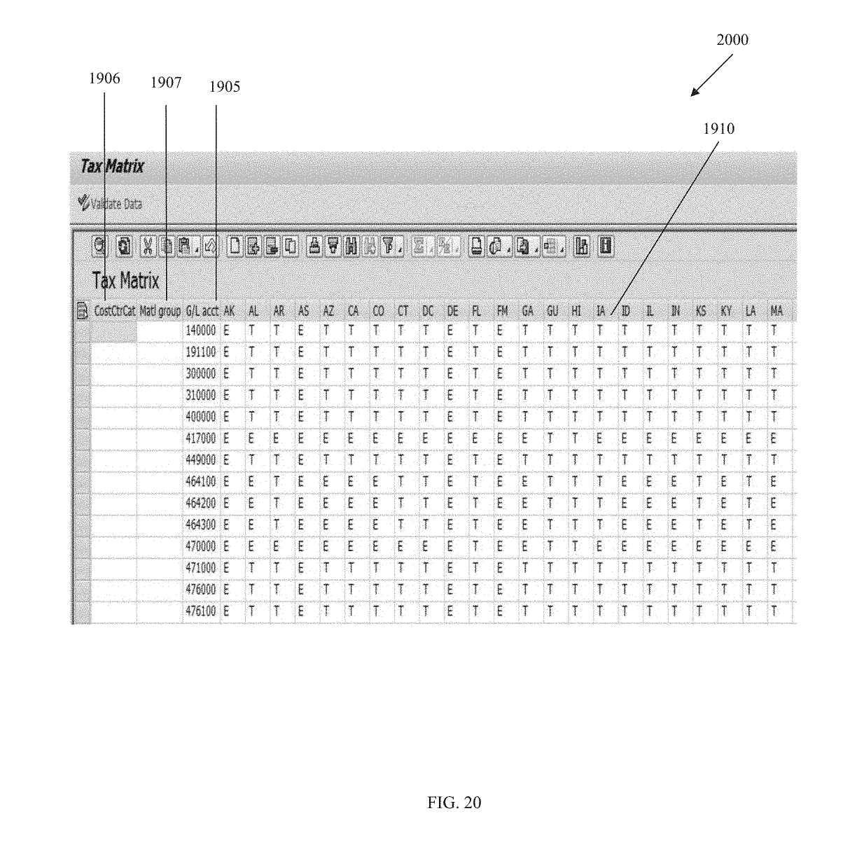

FIG. 20 is an illustration of a taxability matrix 2000 that illustrates taxability of purchases, according to principles of the disclosure. The taxability matrix 2000 provides information on a dynamic range of data elements, e.g., GL Account 1905, Material group 1907, or cost object 1906 that can be used singularly or in combination to define the expected taxability of purchases, which may be reconciled on invoices. The taxability matrix 2000 may indicate whether the data elements are taxable “T” or exempt “E” across jurisdictions 1910, such as by state.

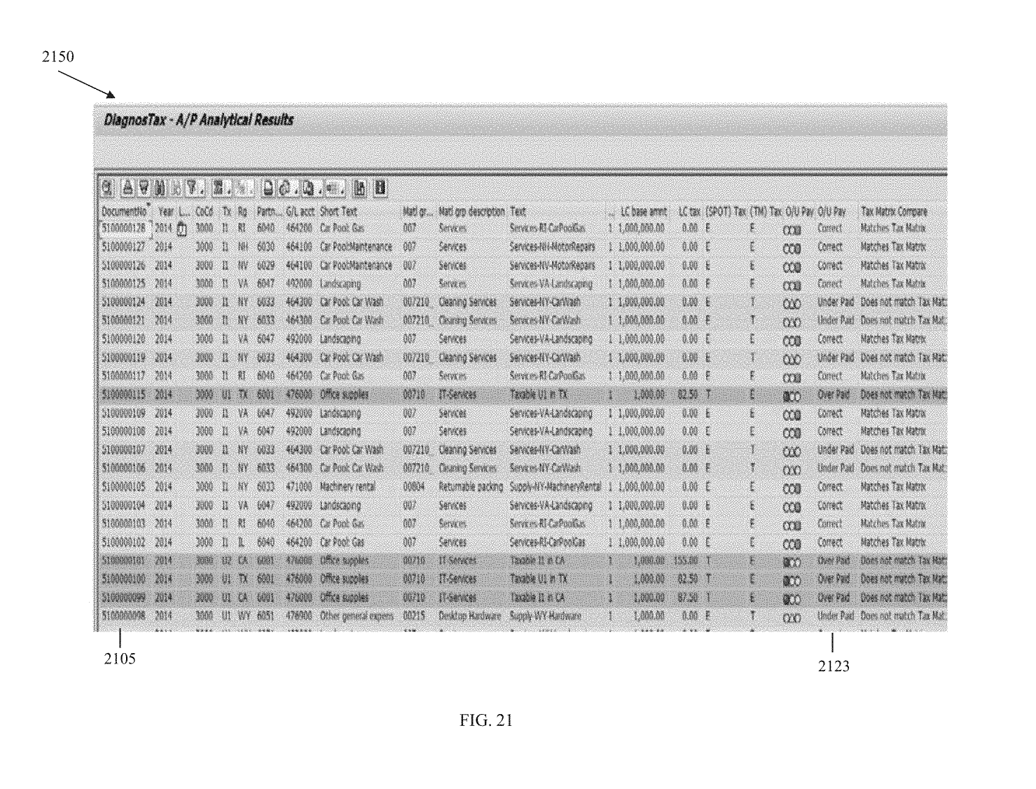

FIG. 21 is an example illustration of an output 2150 in spreadsheet format showing actual tax outcomes for every A/P invoice line selected for processing and compares the result to an expected tax outcome or rules override, according to principles of the disclosure. For each A/P invoice shown in column 2015 or GL account 2117, the result may be displayed with color coding showing whether or not a tax was correctly paid, underpaid, or overpaid as shown in column 2123.

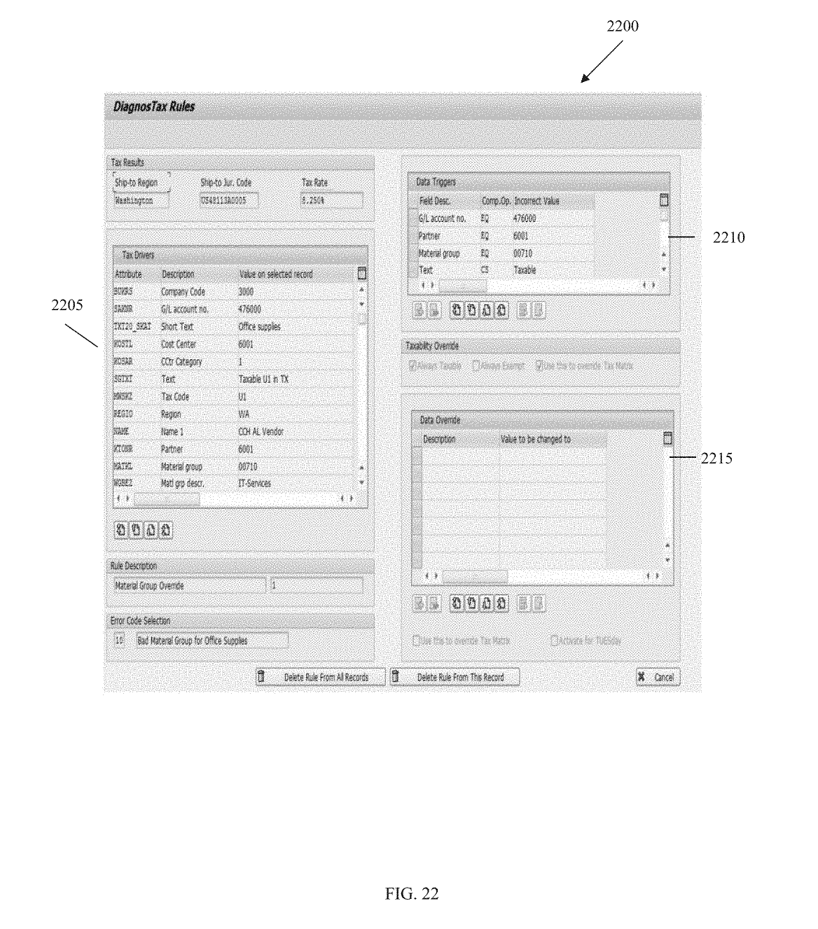

FIG. 22 is an example of a user interface 2200 for displaying or assigning rules 111 to SAP data elements as captured by the extract user interface 1900 user selections 1950 (“drivers”), in accordance with principles of the disclosure. These “drivers’ from the extract user interface 1900 may assign rules to combinations of those “drivers.” The driver rules may be based on exact or partial value matches to facilitate key-word analysis and outcome assignments. This feature allows correction or override of bad data inputs or incorrect information and permits automatic outcome assignments, including corrected ERP records such as A/P records. This capability also permits correction of bad data in similar transactions, thereby facilitating a system that “learns” from overrides.

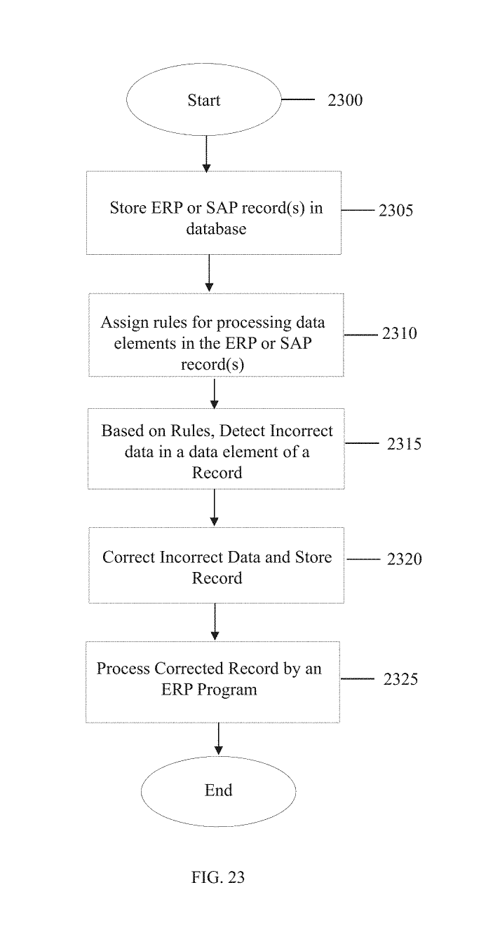

FIG. 23 is an example process for detecting and correcting ERP/SAP records, starting at step 2300. At step 2305, ERP/SAP records may be stored in the database 110, some of the records may be stored with incorrect, damaged or improperly entered data. At step 2310 one or more rules 111 may be assigned (e.g., using an interface as shown in FIG. 22) for processing data elements for the ERP/SAP records to detect incorrect or erroneous information and to possibly override that information based on the assigned rule or rules. The corrected ERP/SAP record may be stored in database 110. At step 2315, based on an assigned rule or rules, incorrect or erroneous information may be detected in a data element of an ERP/SAP record. This detection may involve partial or entire text matching of one date elements against know recognized permitted text fields. Moreover, based on geographic location denoted in the ERP/SAP record, the partial or full text match may be weighted to include the geographic location designation in determining whether or not a field is correct or incorrect. For example, if one data element denotes a jurisdiction, then if the jurisdiction is Texas, then the partial or full text matching of a second field may be altered to permit a different type of match, as compared with another jurisdiction designation such as, e.g., New York. In this manner, the error detection may be altered or recalibrated based on the geographic or jurisdiction of a data element in the ERP/SAP record. Other text matching based on rules may be weighted to include gender, jurisdictions, country, dates, range of dates, type of legal entity such as, e.g. profit or non-profit, based on a value or range of values being matched, the value or range of value exceeding or not exceeding a predetermined limit. At step 2320, the corrected data record may be stored for subsequent processing. At step 2325, the corrected data record may be processed by an ERP program such as a material handling program, a human resources program, or a tax computation program, such as described above.

While the disclosure makes reference to specific systems that may be used to implement the disclosed methods, any appropriate system or systems may be used, as will be understood by one skilled in the art, without departing from the spirit and scope of the disclosure.

It should also be noted that the software implementations of the invention as described herein are optionally stored on a tangible storage medium, such as: a magnetic medium such as a disk or tape; a magneto-optical or optical medium such as a disk; or a solid state medium such as a memory card or other package that houses one or more read-only (non-volatile) memories, random access memories, or other re-writable (volatile) memories. A digital file attachment to email or other self-contained information archive or set of archives is considered a distribution medium equivalent to a tangible storage medium. Accordingly, the invention is considered to include a tangible storage medium or distribution medium, as listed herein and including art-recognized equivalents and successor media, in which the software implementations herein are stored.

While the invention has been described in terms of exemplary embodiments, those skilled in the art will recognize that the invention can be practiced with modifications in the spirit and scope of the appended claims. These examples given above are merely illustrative and are not meant to be an exhaustive list of all possible designs, embodiments, applications, or modifications of the invention.

What is claimed:

1. A method for detecting and correcting incorrect data in an enterprise resource planning (ERP) system, the method comprising:
storing an ERP record in an ERP database, the ERP record having a least one incorrect data element, the ERP database configured to store a plurality of ERP records each record having a plurality of data elements;
assigning a plurality of rules for processing a plurality of ERP data elements for the database of ERP records;
based on at least one of the rules, detecting incorrect data in one of the plurality of ERP data elements in a first ERP record based on a key word match in a second data element of the plurality of ERP data elements in the first ERP record;
correcting the incorrect data in the first ERP record and storing the corrected first ERP record in the database; and
after the correcting, processing the corrected record by an ERP program associated with the ERP system.

2. The method of claim 1, wherein the rules are associated with at least one of: any one of the plurality of ERP data elements, a company code, a general ledger (GL) account, a short text field, a cost center, material group, a pre-defined category and a geographic jurisdiction.

3. The method of claim 1, further comprising correcting incorrect data in a second ERP record based on the detection of incorrect data in the first record.

4. The method of claim 1, wherein the ERP program comprises a tax software program independently installable and operable to execute on the ERP system and configured to execute the one or more function calls including configured to execute logic to determine accuracy of a tax item related to an invoice or a purchase order; and further comprises:
outputting an indication of accuracy of the tax item.

5. The method of claim 4, wherein the ERP program is configurable to determine an output based on variables such as tax codes, invoice thresholds, vendors, states, overpayment vs. underpayment and taxability.

6. The method of claim 4, wherein the ERP program is configurable to determine whether one of: a purchase order based invoice and a non-purchase order based invoice has an inaccurate tax amount and provides an output indicative of a correct tax amount or indicative of no change.

7. The method of claim 4, wherein the ERP program is configurable to operate at a line or invoice level, and configurable to process manually input invoices and automatic invoices.

8. The method of claim 4, wherein the ERP program tax software reconciles the invoice by indicating at least one of:
pay a vendor as billed;
accrue tax if not billed by the vendor;
accrue partial tax not billed by the vendor; and
short-pay the vendor.

9. The method of claim 4, wherein a configuration table setting in a memory determines whether or not the tax software program is to be called using the one or more remote function calls.

10. The method of claim 9, wherein the configuration table setting determines whether or not the tax software program is to be called based on one of: a type of document, tax code, company code and a country.

11. The method of claim 4, wherein the tax software program is configured to calculate and record tax accruals on financial transactions.

12. The method claim 11, wherein the tax software program is configured to create a FI document and post a tax accrual to a general ledger.

13. The method of claim 1, wherein the at least one incorrect data element is incorrectly entered by a user or was electronically damaged.

14. The method of claim 4, wherein the tax software program analyzes gaps in reporting data between a third party tax software and the ERP tax software and provides data for internal audits or external audits and identifies gaps in reported tax amounts.

15. A computer program product embodied on a computer readable medium and comprising executable code for detecting and correcting incorrect data in an enterprise resource planning (ERP) system, the method comprising when read and executed by a computer causes the execution of the following steps:
storing an ERP record in an ERP database, the ERP record having a least one incorrect data element, the ERP database configured to store a plurality of ERP records each record having a plurality of data elements;
assigning a plurality of rules for processing a plurality of ERP data elements for the database of ERP records;
based on at least one of the rules, detecting incorrect data in one of the plurality of ERP data elements in a first ERP record based on a key word match in a second data element of the plurality of ERP data elements in the first ERP record;
correcting the incorrect data in the first ERP record and storing the corrected first ERP record in the database; and
after the correcting, processing the corrected record by an ERP program.

16. The computer program product of claim 15, wherein the rules are associated with at least one of: any one of the plurality of ERP data elements, a company code, a general ledger (GL) account, a short text field, a cost center, material group, a pre-defined category and a geographic jurisdiction.

17. The computer program product of claim 15, further comprising correcting incorrect data in a second ERP record based on the detection of incorrect data in the first record.

18. The computer program product of claim 15, wherein the ERP program comprises a tax software program independently installable and operable to execute on the ERP system and configured to execute the one or more function calls including configured to execute logic to determine accuracy of a tax item related to an invoice or a purchase order; and further comprises:
outputting an indication of accuracy of the tax item.

19. The computer program product of claim 18, wherein the ERP program is configurable to determine an output based on variables such as tax codes, invoice thresholds, vendors, states, overpayment vs. underpayment and taxability.

20. The computer program product of claim 18, wherein the ERP program is configurable to determine whether one of: a purchase order based invoice and a non-purchase order based invoice has an inaccurate tax amount and provides an output indicative of a correct tax amount or indicative of no change.

21. The computer program product of claim 18, wherein the ERP program is configurable to operate at a line or invoice level, and configurable to process manually input invoices and automatic invoices.

22. The computer program product of claim 18, wherein the ERP program tax software reconciles the invoice by indicating at least one of:
pay a vendor as billed;
accrue tax if not billed by the vendor;
accrue partial tax not billed by the vendor; and
short-pay the vendor.
